(19) United States
(12) Patent Application Publication
(10) Pub. No.: US 2013/0059707 A1
(43) Pub. Date: Mar. 7, 2013

(54) MACHINE FOR PRODUCING CARDBOARD CUTOUTS

(71) Applicants: Fabrice Sauvageot, Octeville-Sur-Mer (FR); Patrick Arcelaine, Octeville-Sur-Mer (FR); Didier Mougin, Octeville-Sur-Mer (FR)

(72) Inventors: Fabrice Sauvageot, Octeville-Sur-Mer (FR); Patrick Arcelaine, Octeville-Sur-Mer (FR); Didier Mougin, Octeville-Sur-Mer (FR)

(73) Assignee: SIDEL PARTICIPATIONS, OCTEVILLE-SUR-MER (FR)

(21) Appl. No.: 13/697,685

(22) PCT Filed: Jun. 23, 2011
(86) PCT No.: PCT/FR2011/051443

§ 371 Date: Nov. 13, 2012

(30) Foreign Application Priority Data
Jun. 29, 2010 (FR) 10 55203

(51) Int. Cl. B31B 3/00

(52) U.S. Cl. 493/52

(57) ABSTRACT

The invention relates to a machine for producing cardboard cutouts, comprising a magazine (3) which projects outside the closed chamber of said machine, and a window (10) in one of the walls of said chamber for feeding said cutouts into said chamber. Said machine includes at least two associated sensors (15 and 16), which are positioned in the immediate vicinity of the window (10); said sensors are slightly offset such that, in particular, one or the other causes the complete and absolute stoppage of the machine before said window is opened. The two sensors (15, 16) are of different types, and the operations thereof are based on separate physical principles: one (15) of the sensors consists of a photoelectric cell, and the other sensor (16) is an ultrasonic sensor.

### OBJECT OF THE INVENTION

The invention relates to an improvement to machines for shaping and erecting cardboard cutouts, known in the industry as blanks, and more particularly an improvement to the magazine containing said blanks which is associated with this type of machine.

### PRIOR ART, PROBLEMS, AND SOLUTIONS

Safety concerns regarding these machines for unfolding and/or erecting blanks have led to the installation of protections, walls and doors, to isolate the various mechanisms and eliminate risk for operators working with this type of machine.

However, possibilities remain for access to these machines, such as the access corresponding to the entrance where cardboard blanks are fed to the machine via the magazine, whether these are blanks for slotted boxes, wrap-around style blanks, or tray blanks.

The machine is fed with blanks from a magazine which projects outside the machine enclosure (chamber) and is regularly filled by an operator.

When it is completely empty, this magazine allows access via the window where blanks are fed into the machine enclosure, and this access opens towards mechanisms such as the extraction arms or the carriage system for advancing the blanks towards the erecting station.

The invention proposes an arrangement of the magazine which improves operator safety by eliminating any possibility of access through this gaping hole created by the window, to prevent the possibility of entry inside the machine enclosure while it is running.

### BRIEF DESCRIPTION OF THE INVENTION

The machine for unfolding and/or erecting cardboard blanks according to the invention comprises: —a magazine which projects outside the enclosure around said machine, and—a window which allows said blanks to be fed into said enclosure. The machine comprises at least two sensors which are associated with and positioned in the immediate vicinity of said window in order to detect the presence of a minimum amount of blanks within the opening of said window, as these blanks prevent access to the inside of said enclosure due to the added distance. Said sensors are slightly offset along the axis by which said blanks are fed into said enclosure such that, in particular, one or the other causes the complete and absolute stoppage of the machine, also known as an emergency shutdown, when said minimum amount of blanks is reached, meaning before said window provides a gaping opening.

With this design, a machine meeting the requirements of standard NF EN415-7 2008 can be achieved.

Still according to the invention, the machine for unfolding and/or erecting cardboard blanks comprises sensors positioned to detect, in the window located at the end of the magazine, a minimum of at least five blanks for slotted boxes or at least ten flat blanks for wrap-around boxes or trays, for example.

Still according to the invention, the machine for unfolding and/or erecting cardboard blanks comprises, among the two sensors for detecting blanks within the opening of the window:
an upstream sensor having a function which allows ordering a safety shutdown of the machine which is an emergency shutdown,
and a downstream sensor able to fulfill two functions in case of a failure of said upstream sensor: —a safety shutdown of the machine which is an emergency shutdown, and—lockout to prevent restarting the machine.

In another arrangement of the invention, the machine for unfolding and/or erecting cardboard blanks comprises two sensors of different types, having operations based on separate physical principles: one of the sensors, the downstream sensor, consists of a photoelectric cell, and the other sensor, the upstream sensor, is an ultrasonic sensor, for example.

Still according to the invention, the machine for unfolding and/or erecting cardboard blanks comprises a sensor arranged in the lower part of the window opening, verifying the presence of blanks by detecting their lower portion, and another sensor arranged in the upper part of said window opening, in its central part for example, for verifying the presence of blanks by detecting their upper portion.

In another arrangement of the invention, the machine for unfolding and/or erecting cardboard blanks comprises:
a programmable logic controller (PLC) which verifies that the upstream sensor is working properly by comparing signals from the two sensors: the upstream sensor and the downstream sensor,
a safety relay able to cause an emergency shutdown, initiated by a signal sent by said controller, said safety relay preventing a restart as long as the sensor failure remains unresolved,
a user interface (UI) to keep the operator informed and to allow introducing a password to enable restarting the machine in case of a failure in the upstream sensor.

Still according to the invention, the upstream sensor, which is an ultrasonic sensor, is connected directly to the safety relay so as to trigger immediately an emergency shutdown of the machine without any intervention by the programmable logic controller.

In another arrangement of the invention, the upstream sensor is also connected to the programmable logic controller in order to provide information to the operator through the user interface.

### DESCRIPTION OF FIGURES

The invention is described in a sufficiently clear and complete manner in the following description to permit its implementation. This description is accompanied by drawings, in which:

FIG. 1 is a partial perspective view of a machine for shaping and erecting blanks, showing the magazine of blanks and the window through which these blanks are fed into the enclosure of said machine;

FIG. 2 is a side elevation view of the magazine and the entrance into the machine, showing the position and connection of the various sensors associated with the magazine, for blanks of various sizes.

### DETAILED DESCRIPTION OF THE INVENTION

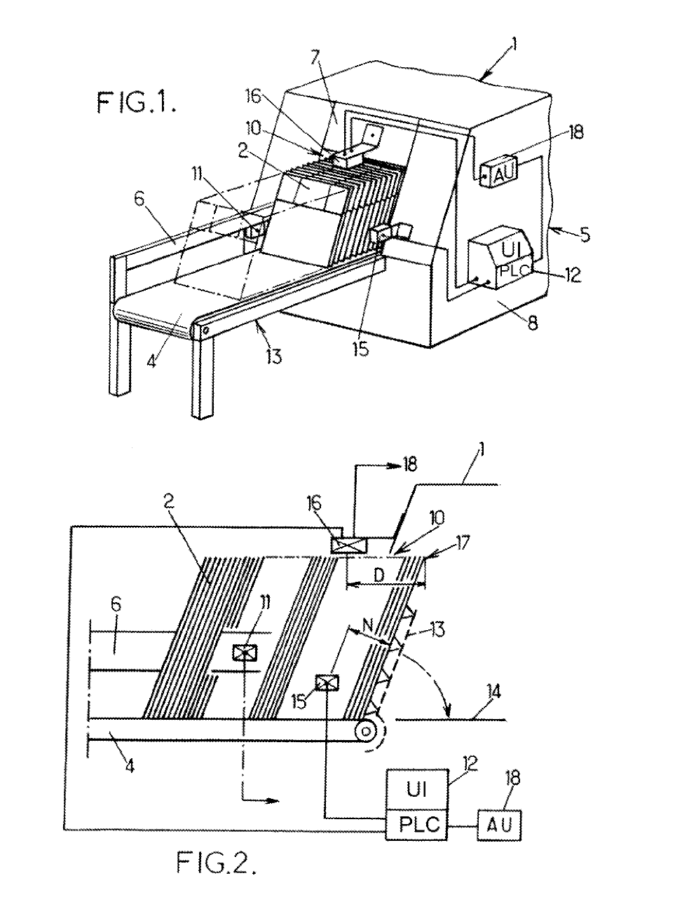

FIG. 1 shows part of a machine 1 for shaping and erecting blanks 2 that have been placed in a magazine 3, on a conveyor belt 4, said magazine 3 projecting outside the enclosure 5 of said machine 1.

This magazine 3 is regularly refilled by an operator or some other person, who places a batch of blanks on the belt of a conveyor 4 which acts as a slider bed.

A guide 6 extends along the side above the conveyor 4, to the front wall 7 of the enclosure of the machine 1, in order to adjust the position of the blanks 2 in the magazine 3.

The enclosure 5 for this machine 1 for unfolding and/or erecting blanks 2 is completely closed off by the protective panels on the sides and front, as partially represented in FIG. 1 where one can see the front wall 7 and the side wall 8.

The front wall 7 contains an opening, or window 10, to allow feeding blanks 2 into the enclosure 5 of the machine; said blanks 2 are brought inside said enclosure 5 by the conveyor belt 4.

The operator is informed of the status of the magazine 3, and in particular of the amount of remaining blanks 2, by means of one or more sensors which act as warning sensors for the supply level to the machine. A sensor 11 is represented on the guide 6 in FIGS. 1 and 2; this sensor 11 informs the operator in a known manner of the fill level status of the magazine 3; it causes the machine cycle to stop, by means of a controller 12, but this stoppage is only effective after a certain number of cycles, programmed in said controller.

If there are no blanks in the magazine 3, the window 10 is unobstructed and allows access to inside the enclosure 5 of the machine 1, where the arm 13 is located which extracts the blanks 2, as represented in FIG. 2, as well as the carriage 14 which moves forward to transfer these blanks 2 to a station, not shown, for shaping and erecting said blanks 2.

Only the presence of blanks 2 in the window 10 isolates the inside of the enclosure 5 of the machine 1 and prevents access to it.

A sensor 15 is placed, for example, at or near the lower edge of the window 10; it allows detecting the presence or absence of blanks 2 at the entrance into the enclosure 5 of the machine 1. This sensor 15 verifies the presence or absence of the lower portion of the blanks 2.

A sensor 16, placed in the upper part of the window 10, also verifies the presence or absence of blanks 2 in the magazine 3; it detects the presence of the upper portion of these blanks 2.

These two sensors 15 and 16 are arranged at a certain distance from the end 17 of the magazine 3, meaning from the location where the blanks 2 are captured by the extraction arm 13, this capture occurring inside the enclosure 5 of the machine 1.

The sensor 16 is located at a distance D from the end 17 of the magazine 3 in order to detect and verify the presence of at least five blanks 2 for slotted boxes, or at least ten flat blanks 2 for wrap-around boxes or trays.

The sensor 15 is located at a distance N from the end 17 of the magazine 3, said distance being noticeably less than the distance D separating the sensor 16 from said end 17.

In fact, sensor 15 is offset relative to sensor 16 in a longitudinal direction which corresponds to the axis by which blanks 2 are fed into the enclosure 5 of the machine.

This sensor 16, which is located upstream from sensor 15, constitutes the safety stoppage sensor, meaning it automatically triggers an emergency shutdown of the machine by means of a safety relay 18.

This emergency shutdown caused by the sensor 16 is intended to maintain a minimum amount of blanks 2 in the magazine 3 in order to keep the window 10 obstructed and prevent access to inside the enclosure 5 of the machine 1. The minimum amount of blanks 2 maintained at the end of the magazine 3 is noticeably greater than the number of blanks which is monitored by the sensor 15.

The sensors 15 and 16, similarly to the sensor 11 for detecting the fill level, are connected to the programmable logic controller 12 (PLC). This controller 12 also verifies that sensor 16 is working properly by comparing the signals from the two sensors 15 and 16.

Sensor 15 is located downstream from sensor 16; it substitutes itself for said sensor 16 if the latter fails. This downstream sensor 15, due to its position, has two functions: —it also monitors and verifies the presence of a minimum amount of blanks 2 at the end of the magazine 3, and, by means of the controller 12 and the safety relay 18, it triggers the emergency shutdown of the machine 1, but also: —it sends the failure information for the sensor 16 to the controller 12.

By means of an appropriate program, the controller 12 sends the failure information for the sensor 16 to the safety relay 18 which prevents the machine 1 from restarting.

It will only be possible to restart the machine after the failure in the sensor 16 is corrected, for example by replacing it, and by clearing this failure by entering a specific security code in the user interface (UI).

This procedure and this verification, using two sensors 15 and 16, allows this type of machine to comply with safety category 2 as defined in standard NF EN954-1.

In a preferred arrangement of the invention, the sensors 15 and 16 are of different types, meaning that their operation is based on separate physical principles. For example, the downstream sensor 15 located in the lower part of the window 12 is a photoelectric cell sensor, and the upstream sensor 16 is an ultrasonic sensor.

1. A machine for unfolding or erecting cardboard blanks, comprising a magazine which projects outside an enclosure around said machine, and, at an end of said magazine, a window arranged in one of the walls of said enclosure to allow said blanks to be fed into said enclosure,
comprising at least two sensors associated with and positioned in the immediate vicinity of said window, said sensors being slightly offset one with respect to the other such that one or the other causes a complete and absolute stoppage of the machine before said window is opened.

2. The machine according to claim 1, wherein said comprises sensors are positioned so as to detect, in said window, a minimum of at least five blanks for slotted boxes or at least ten flat blanks for wrap-around boxes or trays.

3. The machine according to claim 1, wherein one of said two sensors for detecting blanks within an opening of said window is an upstream sensor having a function which allows ordering a safety shutdown of the machine which is an emergency shutdown, and the other of said two sensors is a downstream sensor able to fulfill two functions in case of a failure of the said upstream sensor: —a safety shutdown of the machine which is an emergency shutdown, and—lockout to prevent restarting the machine.

4. The machine according to claim 1, wherein said two sensors are of different types, having operations based on separate physical principles one of said sensors; being a downstream sensor, comprising a photoelectric cell, and the other sensor being an upstream sensor, which is an ultrasonic sensor.

5. The machine according to claim 1, wherein one of said two sensors is arranged in a lower part of said window opening, verifying the presence of blanks by detecting their lower portion, and the other sensor is arranged in an upper part of said window opening, for verifying the presence of blanks by detecting their upper portion.

6. The machine according to claim 4, comprising:
a programmable logic controller which verifies that said upstream sensor is working properly by comparing signals from said two sensors:
a safety relay able to cause an emergency shutdown, initiated by a signal sent by said controller, said safety relay preventing a restart as long as a failure in said upstream sensor remains unresolved,
a user interface to keep an operator informed and to allow introducing a password to enable restarting the machine in case of a failure in said upstream sensor.

7. The machine according to claim 6, wherein said upstream sensor, which is an ultrasonic sensor, is connected to a relay so as to trigger immediately an emergency shutdown of the machine without any intervention by said programmable logic controller.

8. The machine according to claim 7, wherein said upstream sensor is connected to the said programmable logic controller in order to provide information to an operator through said user interface.
